(19) United States
(12) Patent Application Publication
(10) Pub. No.: US 2003/0181998 A1
(43) Pub. Date: Sep. 25, 2003

(54) Device for reliably generating signals

(76) Inventors: Joachim Schenk, Meinersen-Ohof (DE); Volker Breunig, Ditzingen (DE); Frank Schmidt, Leonberg (DE); Achim Mahler, Kehl (DE); Karl Wenzel, Stuttgart (DE); Andre Owerfeldt, Markgroeningen (DE)

Correspondence Address: KENYON & KENYON, ONE BROADWAY, NEW YORK, NY, 10004, US

(21) Appl. No.: 10/221,003

(22) PCT Filed: Feb. 15, 2001
(86) PCT No.: PCT/DE01/00565

(30) Foreign Application Priority Data
Mar. 9, 2000 (DE) 100 11 410.5

(51) Int. Cl. G05B 11/01; G05B 13/02; G05B 9/02

(52) U.S. Cl. 700/39; 700/82; 700/21; 700/79

(57) ABSTRACT

A device for reliably generating signals, which includes a control means (10) that is supplied a control signal (12). The control means (10) generates a trigger signal (13, 14) as a function of the control signal (12), in order to trigger a load (50). Emergency operating means (30, 32) are provided, which, in an emergency operation, generate the trigger signal (34, 14) as a function of the control signal (12).

### BACKGROUND INFORMATION

The present invention starts out from a device for reliably generating signals according to the species defined in the independent claims. In today's systems, signals that are critical with regard to safety, such as terminal control signals of an ignition switch, are directly transmitted to the signal drain. However, if a signal critical with regard to safety is generated by a microcontroller, it must be ensured that its safety-critical output signal does not change into an incorrect state or can no longer be switched over from the one state to another state, when a single-chance fault occurs.

Therefore, the object of the present invention is to increase the reliability of preparing the signal, using a microcontroller. This object is achieved by the features of the independent claims.

### SUMMARY OF THE INVENTION

The device of the present invention for reliably generating signals includes a control means, which receives a control signal. The control means generates a trigger signal as a function of the control signal, in order to trigger a load. The present invention provides for emergency operating means, which generate the trigger signal in place of the control means during emergency operation. The redundant generation of the trigger signal increases the reliability of the entire system, since, in the case of the control means malfunctioning, the emergency operating means are still available for generating the trigger signal in an emergency operation. This ensures correct triggering, in particular in the case of signals that are critical with regard to safety, such as the terminal control signal for an ignition switch. When errors occur in a component in the system, the trigger signal does not change into an incorrect state, and may also not be switched over into another state. To accomplish this, the control signal is to be advantageously supplied to the emergency operating means as well, which generate the trigger signal from this control signal during emergency operation.

An advantageous further refinement provides triggering means, which are used to activate the emergency operating means and activate the emergency operating means when a fault is detected in the control means. The switchover to emergency operation and the corresponding control by the emergency operating means is only carried out in an emergency. However, the control means continues to generate the trigger signal during normal operation. This allows the complexity of the emergency operating means to be reduced, since, in normal operation, the control means assumes the normally more complex functionality.

Additional advantageous refinements are derived from additional, dependent claims and the description.

### BRIEF DESCRIPTION OF THE DRAWING

The exemplary embodiments of the present invention are represented in the drawing and explained in detail below.

FIGS. 1 through 3 show block diagrams of several exemplary embodiments of the device according to the present invention for reliably generating signals.

### DESCRIPTION OF THE EXEMPLARY EMBODIMENTS

A control signal 12 is supplied to a control means 10 and an emergency operating means 30. Control means 10 generates an output signal 13, which is supplied to emergency-operation switching element 32. A trigger signal 18 supplied by control means 10 is processed by a monitoring means 20. Control means 10 also generates an emergency-operation trigger signal 15 for emergency operating means 30. Emergency operating means 30 also receives a monitoring output signal 22 generated by a monitoring means 20. Emergency operating means 30 generates an emergency-operation output signal 34 and an emergency-operation control signal 36. The switch position of emergency-operation switching element 32 may be changed, using emergency-operation control signal 36. In the one switch position, emergency-operation switching element 32 transmits output signal 13 of control means 10 to a switching element 16, in the form of trigger signal 14. In the other switch position, emergency-operation switching element 32 transmits emergency-operation output signal 34 of emergency operating means 30 to switching element 16, in the form of trigger signal 14. A component that is critical with regard to safety may be activated or deactivated by switching element 16, which is switched by trigger signal 14.

In the exemplary embodiment according to FIG. 2, control means 10 is supplied a control signal 12 and a reset signal 24, which is generated by monitoring means 20.

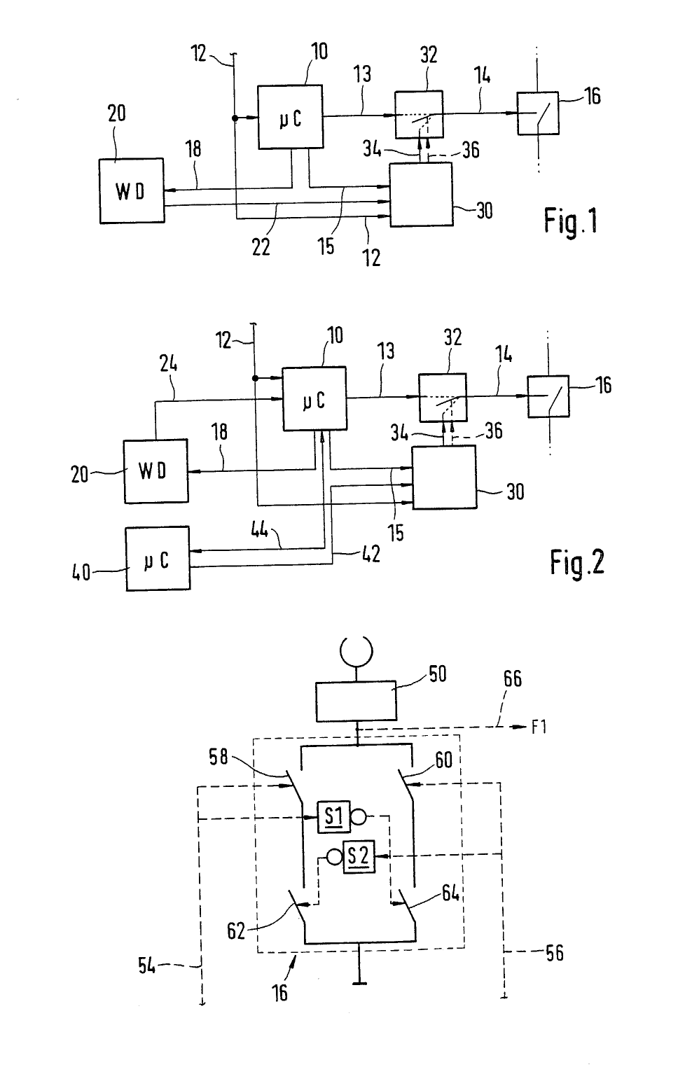

Control means 10 in turn transmits output signal 13 to emergency-operation switching element 32, transmits trigger signal 18 to monitoring means 20, and transmits emergency-operation trigger signal 15 to emergency operating means 30. As previously described in connection with the exemplary embodiment according to FIG. 1, emergency operating means 30 outputs emergency-operation signal 34 and emergency-operation control signal 36 to emergency-operation switching element 32, whose output signal is supplied to switching element 16 in the form of trigger signal 14, for reasons of triggering. A second control means 40 is provided, which exchanges data with control means 10 via communication line 44. An emergency-operation trigger signal 42 of second control means 40 is transmitted to emergency operating means 30.

In the exemplary embodiment according to FIG. 3, a first trigger signal 54 is transmitted to both a first inverter 51 and a first switching element 58. A fourth switching element 64 is controlled by the output signal of first inverter 51. A second trigger signal 56 is supplied to both a second switching element 60 and a second inverter 52. The output signal of second inverter 52 is used as a trigger signal for third switching element 62. First switching element 58 and third switching element 62 are connected in series, as are second switching element 60 and fourth switching element 64. First switching element 58 and third switching element 62 are connected in parallel to series-connected, second and fourth switching elements 60, 64. The common potentials of third and fourth switching elements 62, 64 are (for example) connected to ground, and the common potentials of first and second switching elements 58, 60 are (for example) connected to load 50. A feedback line 66 is provided for detecting the signal that triggers load 50.

The exemplary embodiment according to FIG. 1 is used, for example, to reliably generate signals for an ignition switch in a motor vehicle. The appropriate signal of the desired ignition state is transmitted in the form of control signal 12, to both control means 10 and emergency operating means 30. Control means 10 processes incoming control signal 12, possibly with the aid of further information. Automatic start-stop control, which automatically deactivates or activates the ignition (for example, for a load 50) when certain conditions are present, may be implemented in control means 10. Therefore, control means 10 generates an output signal 13 as a function of control signal 12, the output signal triggering switching element 16 during normal operation, in order to, e.g. activate or deactivate the ignition.

Since the ignition is a function that is critical with regard to safety, switching element 16 must also be correctly triggered when control means 10 is not operating properly. To this end, the present invention provides emergency operating means 30 along with corresponding emergency-operation switching element 32. When there is a fault in control means 10, emergency operating means 30 controls emergency-operation switching element 32 in such a manner, that emergency-operation switching element 32 no longer feeds through output signal 13 of control means 10 as a trigger signal 14 for switching element 16, but rather feeds emergency-operation output signal 34 through. Emergency-operation output signal 34 is the corresponding state of control signal 12. In the simplest case, control signal 12 is merely fed through by emergency operating means 30 as emergency-operation output signal 34. However, an additional logic circuit, which converts control signal 12 into emergency-operation output signal 34 as a function of certain conditions, could be integrated into emergency operating means 30.

Emergency-operation switching element 32 is then switched over for transmitting emergency-operation output signal 34 as a trigger signal, when faulty operation of control means 10 is detected. Either control means 10 itself or monitoring means 20 may activate the emergency operating function of emergency operating means 30. To this end, a self-diagnosis function is integrated into control means 10, in order for it to monitor its own operability. If control means 10 detects its own fault, it transmits a corresponding status message to emergency operating means 30, using emergency-operation trigger signal 15, in order to activate the emergency operating function as described above. Monitoring means 20 is provided to additionally or alternatively monitor control means 10. It could be a so-called watchdog. Control means 10 outputs a trigger signal 18 to monitoring means 20. Monitoring means 20 checks if incoming trigger signal 18 matches an expected trigger signal. A frequency deviation of trigger signal 18 could be used, for example, as a fault criterion. If monitoring means 20 detects a significant deviation of trigger signal 18 from the expected, normal state, it concludes that control means 10 is defective and activates the emergency operating function of emergency operating means 30, using an appropriate monitoring output signal 22. Using emergency-operation control signal 36, emergency operating means 30 causes emergency-operation output signal 34 to be fed through as the trigger signal 14 for switching element 16, as previously described. However, in the exemplary embodiment according to FIG. 1, monitoring means 20 does not cause control means 10 to reset, but just controls the emergency operating function of emergency operating means 30.

In the exemplary embodiment according to FIG. 2, a second control means 40 is provided as a further means for monitoring control means 10. Second control means 40 monitors the operability of control means 10, using, in some instances, bidirectional communication, which is conducted between first control means 10 and second control means 40 via communication line 44. To this end, second control means 40 could transmit, for example, test signals to control means 10, which sends back appropriate response signals. Using the incoming response signals, second control means 40 determines if control means 10 is still functioning properly. If the received response of control means 10 deviates from the one expected, second control means 40 concludes that the control means is operating incorrectly and activates the emergency operation stored in emergency operating means 30, using emergency-operation trigger signal 42. The emergency operation corresponds to the one described in exemplary embodiment 1. Reference is made to the following explanations. Second control means 40 essentially assumes the function of the monitoring means 20 of the first exemplary embodiment. Therefore, the monitoring means 20 according to FIG. 2 is relieved of these tasks and may take over the so-called watchdog function. Monitoring means 20 in turn checks trigger signal 18 for significant, unexpected deviations. If such deviations occur, monitoring means 20 transmits an appropriate reset signal 24 to control means 10. Control means 10 is run up to speed again. Second control means 40 detects this reset and, at the latest that this point, activates the emergency operating function of emergency operating means 30. As is also the case with the exemplary embodiment according to FIG. 1, control means 10 may itself activate the emergency operating function of emergency operating means 30. This could then be the case, when control means 10 itself recognizes that it is functioning incorrectly and/or when it detects a fault in second control means 40. Alternatively, the emergency operating function of emergency operating means 30 may be triggered by monitoring means 20 after a specifiable number of reset signals 24. In this case, the so-called watchdog function of monitoring means 20 is maintained.

In order to further increase reliability, switching element 16 may have a design as represented in FIG. 3. Control means 10 would generate two signals, the first and the second trigger signals 54, 56, in place of just one output signal 13. Only one of the two trigger signals 54, 56 would have to be designed to be fault-tolerant (as described above). In the case of a fault, the trigger signal that is not fault-tolerant must only assume a specific state. In addition, control means 10 receives and processes the signal tapped from feedback line 66. In order to now ensure that switching element 16 opens reliably, a further, third switching element 62 is connected in series with first switching element 58. If, for example, first switching element 58 may no longer open, the desired output signal may still be generated by opening third switching element 62. However, if first switching element 58 may no longer be closed, then the desired output state could be achieved by closing second and fourth switching elements 60, 64.

In the initial state, i.e. when load 50 is switched off, first and second trigger signals 54, 56 have the logical state of zero. Third and fourth switching elements 62, 64 are closed in cooperation with the two inverters 51, 52. Since first and second switching elements 58, 60 still remain open, load 50 is deactivated.

If load 50 is switched on, which is indicated by a change in control signal 12, control means 10 generates a second trigger signal 56 having the logical level of one. This closes second switching element 60. The right path of switching element 16 now becomes conductive and therefore switches load 50 on. Control means 10 simultaneously detects the state of load 50 via feedback line 66. In the case of switching element 16 being operated properly, current flows through load 50 when the logical level of second control signal 56 is one.

If, however, control means 10 does not detect any desired action, despite the desired activation of load 50, the control means changes into emergency operation. In order to remedy the incorrect state, the left path of switching element 16 is activated by changing first control signal 54 into logical one. In so doing, first switch 58 is closed and load 50 is thereby switched on.

If second switching element 60 does not open in normal “de-energized” operation (first trigger signal 54 is logical zero, second trigger signal 56 is logical zero), despite appropriate triggering, this is likewise detected, using the signal acquired from feedback line 66. First trigger signal 54 is then set to logical one, so that fourth switching element 64 opens and the right path is therefore deactivated. This functionality may now be assumed via first trigger signal 54, using the appropriate inverse logic.

What is claimed is:

1. A device for reliably generating signals, having a control means (10) that is supplied a control signal (12), the control means (10) generating a trigger signal (13, 14) as a function of the control signal (12), in order to trigger a load (16, 50),
wherein emergency operating means (30, 32) are provided, which, during an emergency operation, generate the trigger signal (34, 14) as a function of the control signal (12).

2. The device as recited in one of the preceding claims,
wherein triggering means (10, 20, 40) are provided for activating the emergency operating means (30, 32).

3. The device as recited in one of the preceding claims,
wherein monitoring means (10, 20, 40) are provided for monitoring the control means (10).

4. The device as recited in one of the preceding claims,
wherein, in response to improper operation of the control means (10), the monitoring means (10, 20, 40) activate the emergency operating means (30, 32) for generating the trigger signal (14).

5. The device as recited in one of the preceding claims,
wherein the emergency operating means (30) includes at least one switching element (32), which prevents or allows the trigger signal (13) of the control means (10) to be transmitted and/or transmits the output signal (34) of the emergency operating means (30) as the trigger signal (14).

6. The device as recited in one of the preceding claims,
wherein a switching element (16) for activating or deactivating a load (50) is triggered by the trigger signal (13, 14, 34).

7. A device for reliably generating signals, having a control means (10) that is supplied a control signal (12), the control means (10) generating a trigger signal (54, 56) as a function of the control signal (12), in order to trigger a switching element (16) that activates or deactivates a load (50),
wherein detection means (10, 66) are provided for detecting the proper operation of the switching element (16), the detection means (10, 66) controlling the trigger signal (54, 56) as a function of the proper operation of the switching element (16).

8. The device as recited in one of the preceding claims,
wherein the switching element (16) includes at least two switching elements (58, 62; 60, 64) connected in parallel.

9. The device as recited in one of the preceding claims,
wherein the switching element (16) includes at least two switching elements (58, 60; 62, 64) connected in series.

10. The device as recited in one of the preceding claims,
wherein at least two trigger it signals (54, 56) are supplied to the switching element (16).

11. The device as recited in one of the preceding claims,
wherein the output signal of the switching element (16) is detected, via a feedback line (66), by the control means (10) used as detection means, in order to control one of the trigger signals (54, 56).
